(19) United States
(12) Patent Application Publication
(10) Pub. No.: US 2010/0295332 A1
(43) Pub. Date: Nov. 25, 2010

(54) FLEXIBLE DUST DOOR FOR CAPLESS REFUELING SYSTEM

(75) Inventor: Robert Philip Benjey, Dexter, MI (US)

Correspondence Address: Quinn Law Group, PLLC, 39555 Orchard Hill Place, Suite 520, Novi, MI, 48375, US

(73) Assignee: Eaton Corporation, Cleveland, OH (US)

(21) Appl. No.: 12/777,733

(22) Filed: May 11, 2010

Related U.S. Application Data
(60) Provisional application No. 61/180,246, filed on May 21, 2009.

(51) Int. Cl. B62D 25/00; B60K 15/05

(52) U.S. Cl. 296/97.22; 141/350

(57) ABSTRACT

A refueling system is provided that has a door configured to be movable by the nozzle from a closed position that covers the fill opening to an open position that exposes the fill opening. The door has a first portion and a second portion connected with the first portion. The second portion bends with respect to the first portion when the first and the second portions are moved. Bending of the door may help to minimize the packaging space requirements for the system. For example, the door may bend along the length of the fill neck so that it has a smaller lateral dimension in the open position than in the closed position.

### CROSS-REFERENCE TO RELATED APPLICATIONS

This application claims the benefit of U.S. Provisional Application Ser. No. 61/180,246 filed on May 21, 2009, which is hereby incorporated by reference in its entirety.

### TECHNICAL FIELD

The invention relates to a refueling system; and specifically to a door for a fill neck.

### BACKGROUND

Some refueling systems for vehicles are capless, so that a user need not touch any part of the system while refueling. Capless refueling systems may have a protective door to prevent contaminants from entering the fuel system fill neck. The door may be moved from a closed position to an open position by the fuel nozzle itself.

### SUMMARY

A refueling system is provided that has a door configured to be movable by the nozzle from a closed position that covers the fill opening to an open position that exposes the fill opening. The door has a first portion and a second portion connected with the first portion. The second portion bends with respect to the first portion when the first and the second portions are moved. Bending of the door may help minimize the packaging space requirements for the system. For example, the door may bend along the length of the fill neck so that it has a smaller lateral dimension in the open position than in the closed position.

In one embodiment, a housing connected to the fill neck has a housing opening at least partially aligned with the fill opening. A cover is connected to the housing and has a cover opening at least partially aligned with the fill opening and the housing opening. A door is supported between the cover and the housing and is movable by the nozzle from a closed position that covers the fill opening to an open position that exposes the fill opening. The cover interferes with the door to cause the door to bend when the door is moved to the open position.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration in fragmentary cross-sectional view of a refueling system with a door in a closed position, taken at lines 1-1 in FIG. 4;

FIG. 2 is a schematic illustration in fragmentary cross-sectional view of the refueling system of FIG. 1 with the door in an open position and bent, taken at lines 2-2 in FIG. 4;

FIG. 3 is a schematic illustration in perspective view of a housing of the refueling system of FIGS. 1 and 2; and

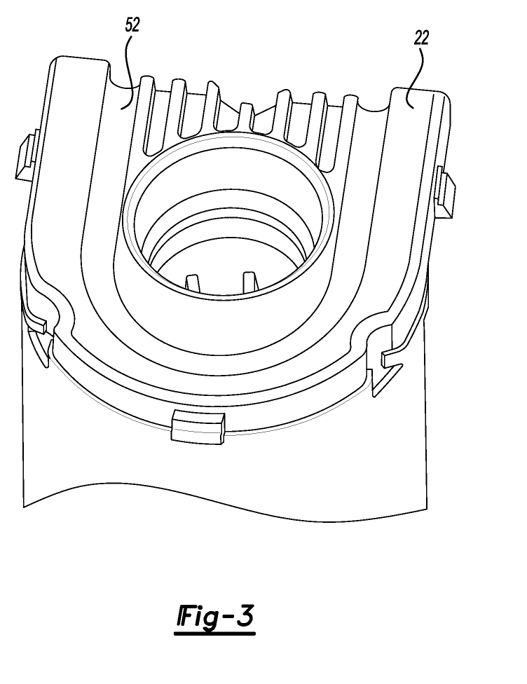

FIG. 4 is a schematic illustration in exploded view of the refueling system of FIGS. 1-3.

### DETAILED DESCRIPTION

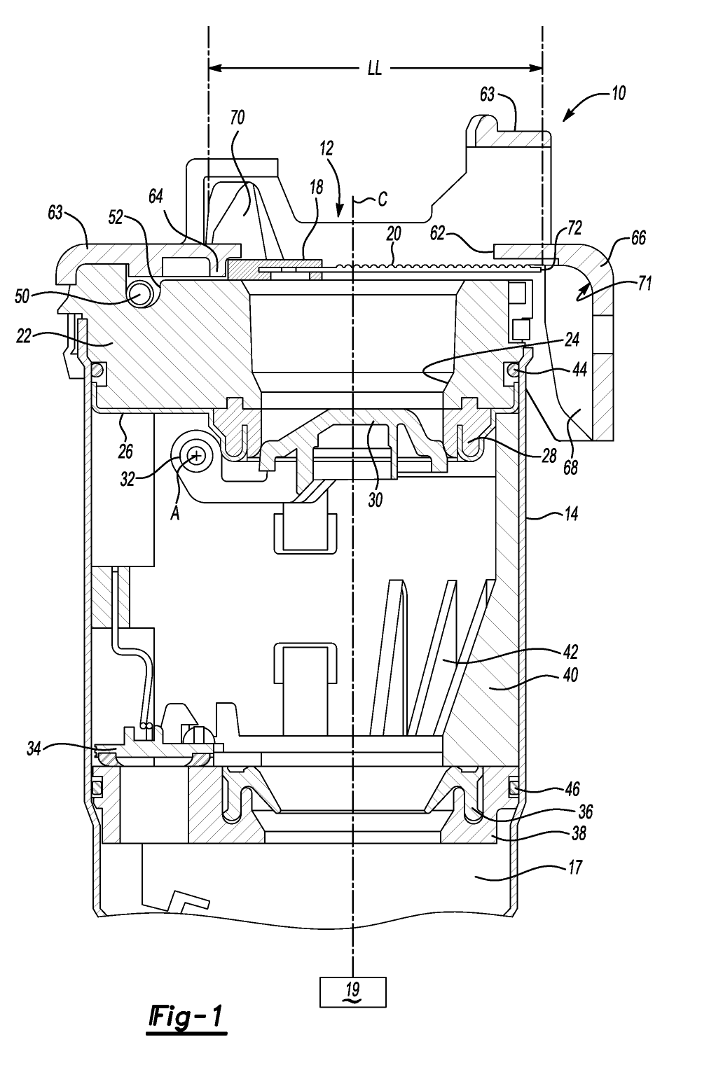

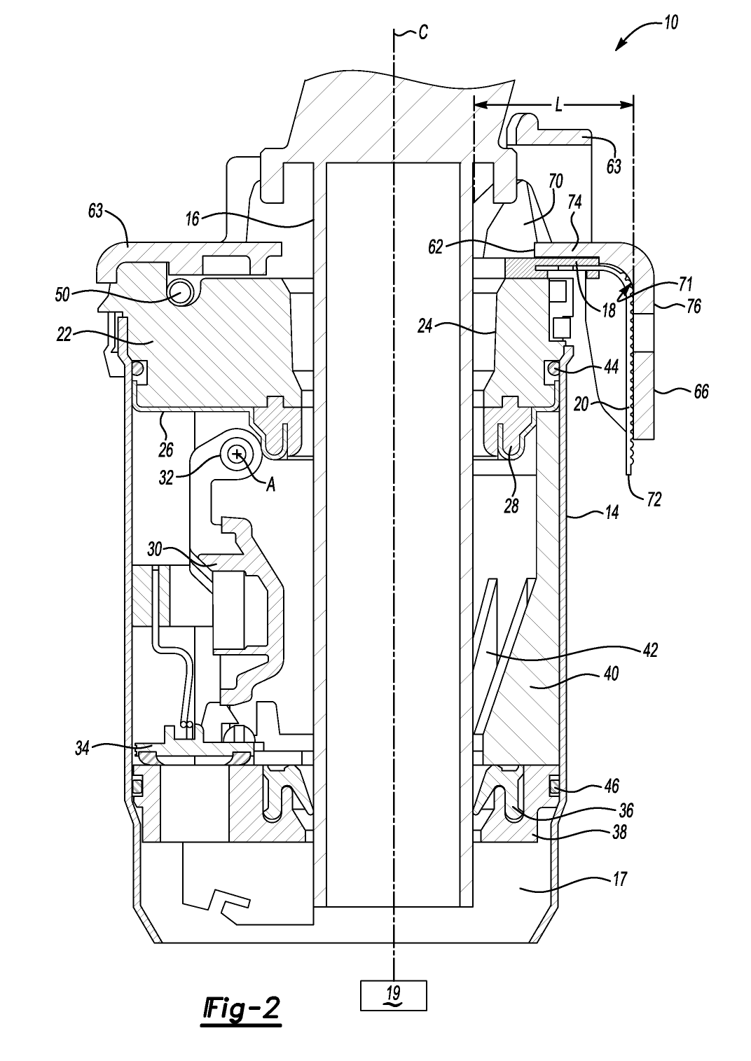

Referring to the drawings, wherein like reference numbers refer to like components throughout the several views, FIG. 1 shows a capless refueling system 10 having a door 12, referred to herein as a dust door, configured to prevent dust and debris from entering the fill neck 14 and designed to increase the compactness of the refueling system 10 as described below. The refueling system 10 has a fill neck 14, sometimes referred to as a fill pipe or fill tube, defining a fill opening 17 configured to receive a fuel-dispensing nozzle 16, shown in FIG. 2, to allow the nozzle 16 to deliver fuel to a fuel tank 19 (shown schematically) through the fill neck.

The door 12 has a first portion 18 and a second portion 20 connected to the first portion 18. The first portion 18 is a substantially rigid component and may be a thermoplastic material. The second portion 20 is bendable. This may be achieved by forming the second portion 20 from a flexible material, such as high-density polyethylene (HDPE), polypropylene, polytetrafluoroethylene (PTFE), or thermoplastic rubber (TPR). Alternatively or in addition, the second portion 20 may be configured to bend by being corrugated, or formed from a series of thin interconnected members, similar to a roll-top desk. In some embodiments, the first and second portions 18, 20 may be integrally-formed from the same material. The advantages of the door 12 are discussed further below.

A housing 22 is supported by the fill neck 14 and has a housing opening 24 that sufficiently aligns with the fill opening 17 to allow the nozzle 16 to be inserted through both openings as shown in FIG. 2. A stamping 26 supports both the housing 22 and a seal 28. A sealing door 30 pivots about pivot point A at hinge 32 from a closed position shown in FIG. 1 to an open position shown in FIG. 2 when the nozzle 16 is inserted. A pressure relief valve 34, a nozzle seal 36 and a nozzle seal support 38 are fit within the fill neck 14. A nozzle guide 40 with ribs 42 helps to direct the nozzle 16 through the nozzle seal 36. Additional ring seals 44, 46 help to prevent vapor leakage.

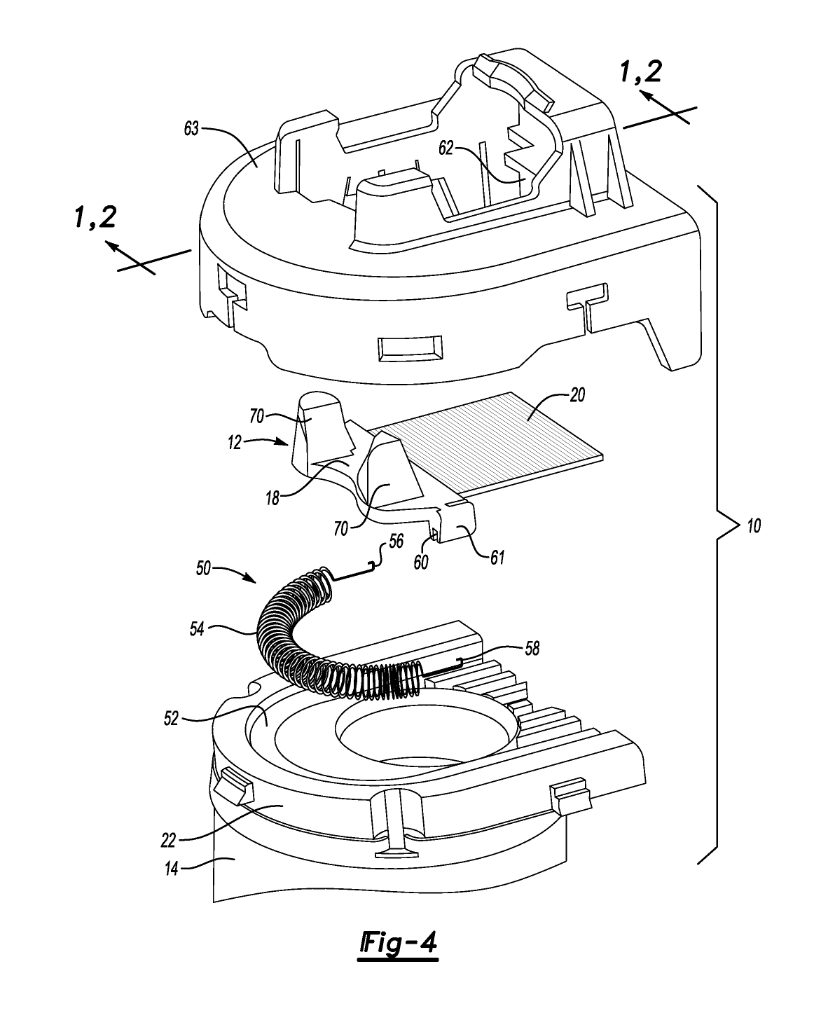

A resilient member 50 rests in a channel 52 formed in the housing 22. In this embodiment, the resilient member 50 is a coil spring. A midportion 54 of the resilient member 50, shown in FIG. 4, is restrained by the housing 22. Referring to FIG. 4, end portions 56, 58 are connected to the first portion 18 of the door 12 through slots 60 (one shown) in arms 61 of the first portion 18. Only one slot 60 and one arm 61 are shown. Another slot 60 and arm 61 that are mirror images of those shown are on the opposing side of the first portion 18. The resilient member 50 biases the door 12 to the closed position of FIG. 1. The arms 61 rest in the channel 52.

A cover 63 defines a cover opening 62 that sufficiently aligns with the fill opening 17 to allow the nozzle 16 to be inserted through the cover opening 62, the housing opening 24 and the fill opening 17, as shown in FIG. 2. A stop 64 of the cover 63 interferes with the first portion 18 to limit movement of the door 12 in a direction toward the midportion 54 of the resilient member 50, thereby defining the closed position. The door 12 is supported between and guided by the housing 22 and the cover 63.

The cover 63 has an extension 66 that extends laterally outward of the fill neck 14 and partially along the fill neck 14 to define a cavity 68 between the extension 66 and the fill neck 14. The first portion 18 has shoulders 70. The nozzle 16 rests against the shoulders 70 as the tip of the nozzle 16 is used to begin pushing the door 12 laterally (i.e. across) the housing 22 and housing opening 24 during insertion of the nozzle 16 into the fill neck 14. The door 12 is initially moved linearly in a lateral direction with respect to a longitudinal axis C of the fill neck 14 by the force of the nozzle 16 against the shoulders 70. An inner surface 71 of the extension 66 interferes with further lateral movement of the second portion 20 of the door 12 when an end 72 of the second portion 20 contacts the inner surface 71. Because the second portion 20 is flexible, the force of the nozzle 16 combined with the interference of the extension 66 causes the second portion 20 to bend in an arcuate manner defined by the shape of the extension 66 at the inner surface 71 to extend in the direction of the longitudinal axis C within the cavity 68. The bending of the second portion 20 allows further lateral movement of the door 12, and allows the nozzle 16 to reach the fully inserted position shown in FIG. 2. The extension 66 guides the door 12.

The lateral dimension of the door 12 in the open position of FIG. 2 is indicated by L. The lateral dimension L of the door 12 is the total length of the door 12 in a direction perpendicular to the longitudinal axis C. The lateral dimension L is much shorter than the lateral dimension LL of the door 12 in the closed position shown in FIG. 1. The extension 66 makes an approximately ninety-degree turn between a longitudinal portion 74 and a side portion 76 of the extension 66, defining the arcuate manner in which the second portion 20 is caused to bend. If the door 12 did not bend, the lateral length of the door 12 in the open position would be much greater, and more lateral packaging space would therefore be required for the refueling system 10.

While the best modes for carrying out the invention have been described in detail, those familiar with the art to which this invention relates will recognize various alternative designs and embodiments for practicing the invention within the scope of the appended claims.

1. A refueling system having a fill neck defining a fill opening configured to receive a fuel-dispensing nozzle comprising:
a door configured to be movable by the nozzle from a closed position that covers the fill opening to an open position that exposes the fill opening; wherein the door has a first portion and a second portion connected with the first portion; and wherein the second portion bends with respect to the first portion when the first and the second portions are moved.

2. The refueling system of claim 1, wherein the fill neck defines a longitudinal axis; and wherein the first portion is linearly movable with respect to the longitudinal axis and the second portion is movable in an arcuate manner with respect to the longitudinal axis.

3. The refueling system of claim 1, wherein the first portion is a substantially rigid material and the second portion is a flexible material.

4. The refueling system of claim 1, wherein the first portion is a thermoplastic material.

5. The refueling system of claim 1, wherein the second portion is corrugated.

6. The refueling system of claim 1, further comprising:
a resilient member operatively connected to the door and configured to bias the door toward the closed position.

7. The refueling system of claim 6, further comprising:
a housing connected to the fill neck and supporting the door; wherein the resilient member is a spring having two end portions connected to the door and a midportion restrained by the housing.

7. The refueling system of claim 1, further comprising:
a cover supported by the fill neck and configured to guide the door between the open and the closed positions and configured to interfere with the second portion to cause the second portion to bend in a direction along the fill neck.

8. The refueling system of claim 7, wherein the fill neck and the cover define a cavity extending along a length of the fill neck; and wherein the second portion is at least partially in the cavity in the open position.

9. The refueling system of claim 1, wherein the first portion has a shoulder against which the nozzle rests when the nozzle moves the door from the closed position to the open position.

10. A refueling system having a fill neck defining a fill opening configured to receive a fuel-dispensing nozzle for dispensing fuel into a fuel tank comprising:
a door configured to be movable by the nozzle from a closed position that covers the fill opening to an open position that exposes the fill opening; wherein the door has a substantially rigid first portion and a flexible second portion connected with the first portion;
a housing connected to the fill neck and supporting the door; and
a cover connected to the housing; wherein the housing and the cover are configured to guide the door as it is moved by the nozzle; and wherein the cover is configured to interfere with the second portion so that the second portion bends with respect to the first portion when the first and the second portions are moved, the door having a dimension that is smaller when the door is in the open position than when the door is in the closed position due to the bending of the second portion.

11. The refueling system of claim 10, wherein the door is a closure of the fill opening most distal from the fuel tank such that the refueling system is capless.

12. The refueling system of claim 10, further comprising:
a resilient member operatively connected to the door and the housing and configured to bias the door to the closed position.

13. A refueling system having a fill neck defining a fill opening configured to receive a fuel-dispensing nozzle comprising:
a housing connected to the fill neck and having a housing opening at least partially aligned with the fill opening;
a cover connected to the housing and having a cover opening at least partially aligned with the fill opening and the housing opening;
a door supported between the cover and the housing and movable by the nozzle from a closed position that covers the fill opening to an open position that exposes the fill opening and permits the nozzle to extend through the cover opening and the housing opening; and wherein the cover interferes with the door to cause the door to bend when the door is moved to the open position.
